(19) United States
(12) Patent Application Publication
(10) Pub. No.: US 2026/0115733 A1
(43) Pub. Date: Apr. 30, 2026

(54) LOW- SPEED MOBILE SHREDDER

(71) Applicant: PRONAR SPOLKA Z OGRANICZONA ODPOWIEDZIALNOSCIA, Narew (PL)

(72) Inventors: Andrzej Chichlowski, Narew (PL); Pawel Bobrowski, Kleosin (PL)

(21) Appl. No.: 19/488,412

(22) PCT Filed: May 21, 2024
(86) PCT No.: PCT/PL2024/000028

§ 371 Date: Nov. 26, 2025

(30) Foreign Application Priority Data
May 30, 2023 (PL) P.445043

(51) Int. Cl. B02C 18/24; B02C 18/14; B02C 21/02

(52) U.S. Cl. CPC B02C 18/24; B02C 18/142; B02C 21/02

(57) ABSTRACT

The subject of the invention is a low-speed mobile shredder used to shred various types of materials, such as municipal and construction waste, pallets, rubble, tree felling remains, roots, extra-large materials, etc. The low-speed mobile shredder with a frame set on a base with a crawler drive system, with a belt conveyor (10), containing a service chamber (1) with a chute (12), at least one shaft (2) with embedded blades (3), and a chute duct (9) between a wall (5) of the service chamber (1) and a drive gear (8) mounted on connecting plates (11), is characterised in that the waste scraper (7), which is located upstream of the coupling (4), is embedded using a shaped connection on the shaft (2) of every drive gear (8), connected to the coupling (4) located in an opening (6) of the wall (5) of the service chamber (1). The waste scraper (7) has the form of a thin-wall element with centrally a positioned mounting hole (7B) and several scraper arms (7A) arranged in a concentric manner, which are bent at an angle a of 90° to 180°. The scraper arms (7A) of the waste scraper (7) are directed at the side wall (5) of the service chamber (1).

The subject of the invention is a low-speed mobile shredder used to shred various types of materials, such as municipal and construction waste, pallets, rubble, tree felling remains, roots, extra-large materials, etc.

For instance, low-speed mobile shredders are known according to EP3566777 presents a mobile shredder with a frame set on a crawler drive, together with a belt conveyor and a shredding unit that contains at least two driven shredding shafts embedded therein, whereas a material feeding area in the form of a tilting chute is created adjacent to the shredding unit. The shaft shredder contains a shaft coupling unit that is designed so that it is switched between a synchronous mode, in which the shredding shafts move in reverse at a defined rotational speed ratio, and an asynchronous mode, in which the shredding shafts move in any direction and without a defined rotational speed ratio. In this way, the shaft shredder can be adopted to meet further requirements for the shredding process. According to the invention, the shredder has gear units coupled with the shredding shafts. Every shredding shaft has the advantages of a separate gear. At the same time, it is provided that at least one of the side walls through which the drive shaft passes is a movable wall, in particular a tilting or sliding wall, that can be moved from the operating position to the service position. Within the meaning of the invention, a side wall can also be any structural element that is suitable for restricting the material feeding area laterally. In this way, the coupling areas, that is the areas where the shredding shaft is coupled with the drive, are exposed. Therefore, in the service position, the bearing areas of at least one shredding shaft are accessible. In this way, the shredding shaft in the service position can be removed from the machine frame without the need for complex disassembly of a portion of the shredding area or complete wall removal.

In two-shaft low-speed shredders used to shred various types of materials, shafts with blades are located in service chambers, and the drive means are located outside the service chambers. To couple the shredding shaft with the drive, the shaft must pass through the service chamber wall. The shredding batch is fed to the service chamber using two shafts with blades that rotate in alternate directions, and the batch is shredded within. There is an issue related to the passing of the shaft through the side wall of the shredding chamber.
Equipment for shredding agricultural feed is known according to US20120061498, where it has an enclosure containing longitudinal walls and transverse walls relative to a compartment for a rotor rotating around the longitudinal axis. The rotor equipped with perimeter processing tools has disks on its ring surfaces, where every disk is concentric relative to the longitudinal axis. The batch is fed to the service chamber where the rotors are installed. The mounting area of the rotating rotors is shifted axially inwards to the enclosure centre near the machine's fixed parts, and a free space is simultaneously created between the enclosure and the rotor. The transverse walls of the shredder allow the rotor to be mounted using supports attached to the external transverse walls. During the shredding process, a fine-grain portion of the batch can penetrate outside the service chamber through the gaps between the shredding shafts and the wall of the service chamber. The material that penetrates a gap is returned to the remaining material flow through the free space between the enclosure and the rotor. Under unfavourable conditions, mainly when a moist and ductile batch is shredded, the material may adhere to the walls of the free space between the enclosure and the rotor, making it impossible to fall freely, which is a serious drawback of this solution.

US20060118671 presents a shredding unit containing a drive shaft and a number of blades mounted on the drive shaft. An independent enclosure has a central area with fixed blades. The enclosure of the service chamber also has side areas with an opening formed in the enclosure wall, in which the rotor and its ring disc are located. A radial distance between the ring disc and the enclosure wall is selected to be sufficiently small to ensure that there is a sealing action relative to the material being fed. Apart from the above, particularly fine particles enter the gap during shredding and leave it outside the enclosure. To capture and remove this material, a metal duct is provided outside the enclosure, within the gap. A drawback is that, from the perspective of strength, the side wall of the enclosure is structurally weakened due to a large opening in which the ring disc is located, which deteriorates the rigidity of the machine's structure. The opening also prevents the rotor from being mounted on the transverse walls of the enclosure, which requires the rotor to be mounted on another support structure.

Another shredder known from U.S. Pat. No. 4,082,232, where the shredder contains a grooved rotating shaft to take up a series of mutually arranged blades. The rotor shaft contains both support bearings and the accurately aligned surfaces of thrust bearings to prevent lateral offset. These take the form of bearing segments or parts, and protect the closer end plates of the shredder enclosure. The shaft has flanges that rotate with the rotor. Flanges rotating in parallel to the thrust bearings prevent direct contact between the material being fed and the enclosure wall, its consumption, and excessive heating on a bypass circuit. A drawback of this solution is that the very fine material enters the gap between the flange and the thrust bearing, which causes the gaps to become clogged over time and increases friction and heating. It is necessary to clean it on a regular basis, and the time required for cleaning extends the downtime.

For this type of low-speed shredder, an issue is the passage of the shaft through the side wall of the shredding chamber in such a way that the shredded material does not leave the shredding chamber in an uncontrolled manner.

The aim of the invention is to improve the low-speed mobile shredder with the passage of the shaft through the chamber wall with the chute duct.

The subject of the invention is a low-speed mobile shredder with a frame set on a base with a crawler drive system, with a belt conveyor, containing a service chamber with a chute, at least one shaft with embedded blades, and a chute duct between a wall of the service chamber and a drive gear mounted on connecting plates, which is characterised in that the waste scraper, which is located upstream of the coupling, is embedded using a shaped connection on the drive gear shaft, connected to the coupling located in an opening of the wall of the service chamber.

It is advantageous when the waste scraper has the form of a thin-wall element with a centrally positioned mounting hole and several scraper arms arranged in a concentric manner, where the bent portion of the scraper arms has a length of 0 to 100 mm.
It is advantageous when the waste scraper has several arms directed toward the side wall of the service chamber.
Advantageously, the scraper arms of the waste scraper are at a distance of 0 to 20 mm from the tangent of the coupling.

The low-speed mobile shredder with the waste scraper removes impurities penetrating the chute duct space, which facilitates the cleaning of the chute duct and the free fall of impurities onto the belt conveyor (the material falling direction is indicated by an arrow) and, farther, transferring them with the shredded material outside the machine. Setting the waste scraper directly on the drive shaft ensures mechanical scraping of the fine-grain moist batch material that adheres to the walls and leaves through the gap formed between the service chamber side wall opening and the shaft coupling. The design of the waste scraper as a thin-wall part, e.g., made of sheet metal, ensures the low weight and resilience of the bent parts and protects them at the same time against overload damage. Additionally, such a design does not require complex process operations, which reduces the installation cost. The small number of arms of the waste scraper gives a larger surface area for the accumulation of impurities, which additionally enhances their removal capacity.

The subject of the invention is reproduced in an embodiment in the drawing, where

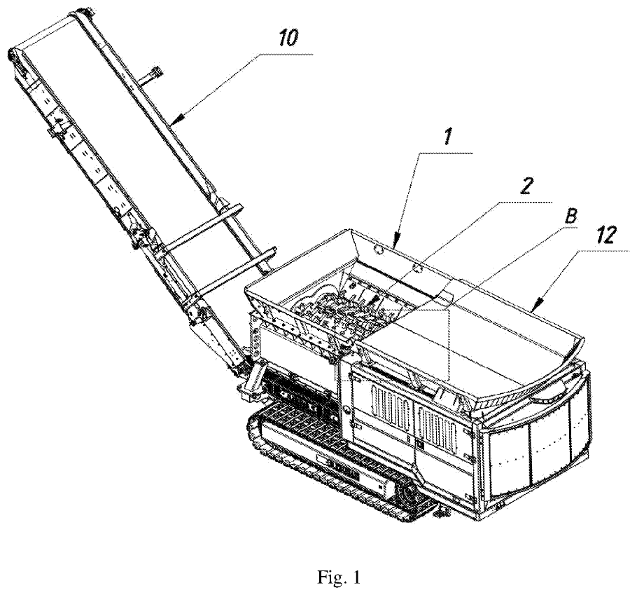

FIG. 1 presents a perspective view of the low-speed mobile shredder,

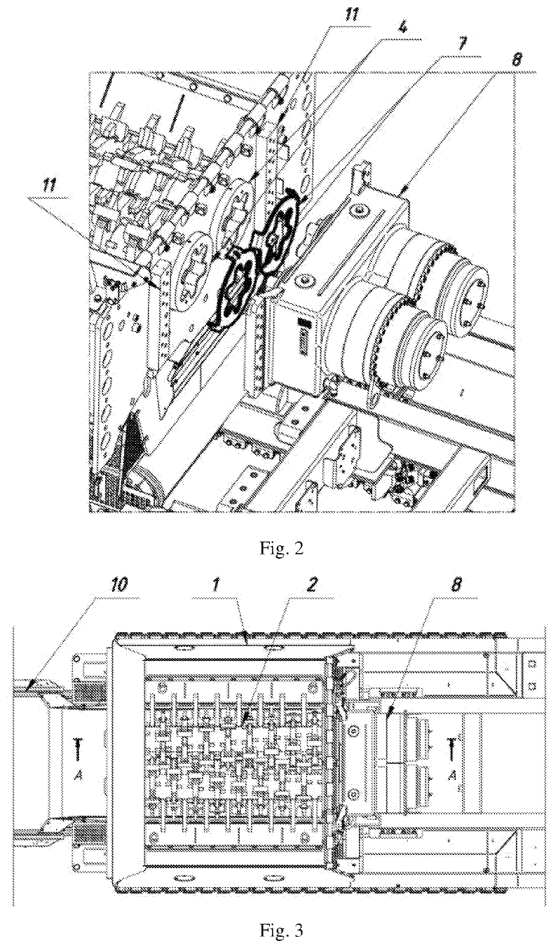

FIG. 2 presents detail B of an exploded view of the drive unit of the low-speed mobile shredder,

FIG. 3 presents a top view of the low-speed mobile shredder,

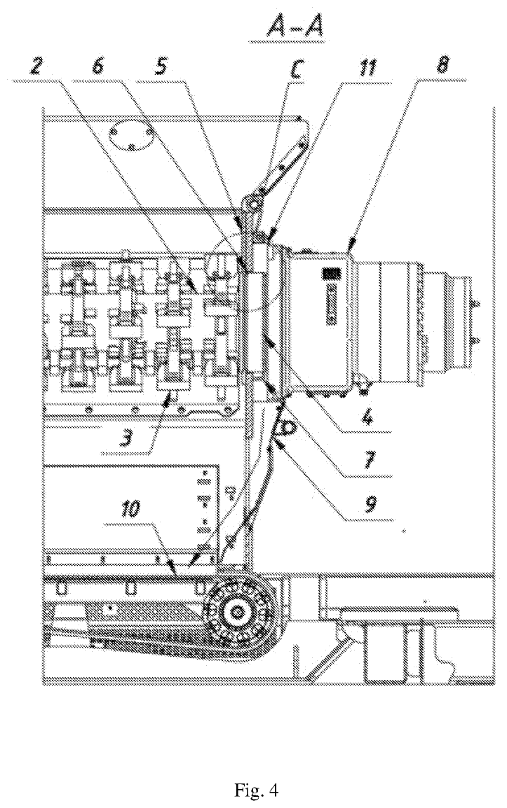

FIG. 4 presents an A-A section of FIG. 2,

FIG. 5 presents detail C of FIG. 4, and

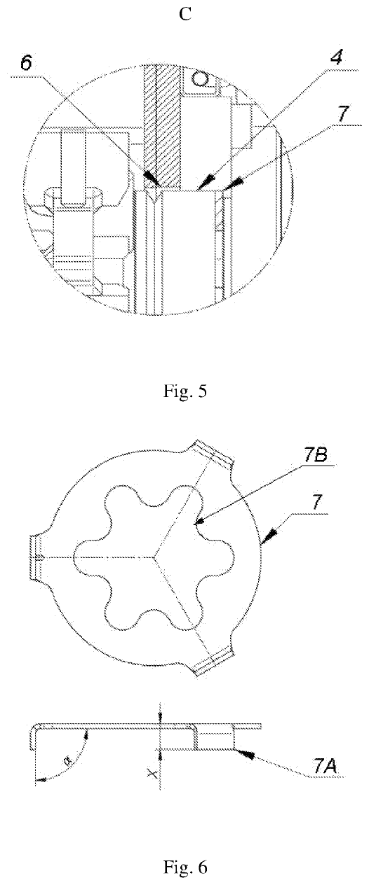

FIG. 6 presents a bottom view and a front view of the waste scraper.

The low-speed mobile shredder contains the frame set on the base with the crawler drive system. The service chamber 1 is mounted on the frame, where the chamber has two shafts 2 with embedded blades 3. The shafts 2 pass through the opening 6 in the wall 5 and are driven using the drive gears 8 through the couplings 4. The waste scraper 7, with the scraper arms 7A directed at the side wall 5 of the service chamber 1, is located between the drive gear 8 and the coupling 4 using the mounting hole 7B. The waste scraper 7 has the form of a thin-wall element with a centrally positioned mounting hole 7B and three scraper arms 7A arranged in a concentric manner, which are bent advantageously at an a angle of 90° to 180°, with a length X of up to 100 mm. The drive gears 8 are mounted on spacers 11 and form the chute duct 9. Under the service chamber 1 there is a belt conveyor 10. Above the service chamber 1 is mounted the tilted chute 12. During the shredding process, the material is fed into the chute 12, which, when lifted, moves the material down to the service chamber 1. A fine-grain portion of the batch may leave the service chamber 1 with the shafts 2 and the embedded blades 3 through the gaps between the openings 6 in the wall 5 of the rear service chamber 2 and the shafts 2 with their couplings 4 to the space between the service chamber 1 and the drive gear 8. This space forms the chute known as the duct 9, formed by, but not limited to, moving away from the drive gear 8 on the connecting plates 11, through which the undesired material transfers to the belt conveyor 10, which transfers the shredded material outside the shredder. In known two-shaft low-speed mobile shredders, under unfavourable conditions, mainly when a moist and ductile batch is shredded, the material may adhere to the walls and clog the free space between the coupling 4 and the opening 6 in the wall 5 of the service chamber 1, making the fine-grain fraction impossible to fall freely. This is a very unfavourable phenomenon, as it may lead to the gradual increase of the openings 6 through which the shafts 2 with the couplings 4 pass and, as a result, to the penetration of an increasing amount of the batch, which, in turn, may damage the drive gear 8 due to the penetration of impurities into its interior. The waste scraper 7 set on the shaft 2 of the gear 8 upstream of the coupling 4, advantageously at a distance of 0 to 20 mm from the tangent of the coupling 4, scrapes the adhered impurities using the scraper arms 7A. It unclogs the space between the opening 6 in the wall 5 of the service chamber 1 and the shaft 2 with the coupling 4, protecting the shredder components.

1. A low-speed mobile shredder with a frame set on a base with a crawler drive system, and belt conveyor, containing a service chamber with a chute, at least one shaft with embedded blades, and a chute duct between a wall of the service chamber and a drive gear mounted on connecting plates, characterized in that a waste scraper, which is located upstream of a coupling, is embedded using a shaped connection on the shaft of every drive gear, connected to the coupling located in an opening of the wall of the service chamber.

2. The low-speed mobile shredder according to claim 1, characterized in that the waste scraper has form of a thin-wall element with centrally a positioned mounting hole and scraper arms arranged in a concentric manner.

3. The low-speed mobile shredder according to claim 2, characterized in that the scraper arms are bent at an angle a of 90° to 180° forming a bent portion.

4. The low-speed mobile shredder according to claim 3, characterized in that the bent portion of the scraper arms of the waste scraper has a length of 0 to 100 mm.

5. The low-speed mobile shredder according to claim 2, characterized in that the scraper arms of the waste scraper are directed at a side wall of the service chamber.

6. The low-speed mobile shredder according to claim 2, characterized in that the waste scraper has several scraper arms.

7. The low-speed mobile shredder according to claim 2, characterized in that the scraper arms of the waste scraper are at a distance of 0 to 20 mm from a tangent of the coupling.
